(19) United States
(12) Patent Application Publication
(10) Pub. No.: US 2020/0336711 A1
(43) Pub. Date: Oct. 22, 2020

(54) PROJECTION DEVICE AND METHOD FOR PROJECTING IMAGE INFORMATION ONTO A PROJECTION SURFACE

(71) Applicant: Robert Bosch GmbH, Stuttgart (DE)

(72) Inventors: Gael Pilard, Wankheim (DE); Frank Fischer, Gomaringen (DE)

(21) Appl. No.: 16/087,991

(22) PCT Filed: Feb. 15, 2017
(86) PCT No.: PCT/EP2017/053356

§ 371 Date: Sep. 24, 2018

(30) Foreign Application Priority Data
Apr. 1, 2016 (DE) 10 2016 205 413.9

(51) Int. Cl. H04N 9/31; G02B 3/14; G03B 21/20; G03B 21/14; G03B 21/00

(52) U.S. Cl. CPC H04N 9/317; G02B 3/14; G03B 21/008; G03B 21/2033; G03B 21/142; H04N 9/3161

(57) ABSTRACT

A projection device for projecting image information onto a projection surface, including a laser for generating a laser beam, a micromirror unit for selectively deflecting the laser beam onto different image points of the projection surface, and magnifying optics, situated in the beam path of the laser beam, downstream from the micromirror unit, for increasing the deflection of the laser beam that is achievable via the micromirror unit. Also described is a method for projecting image information onto a projection surface, a laser beam being generated which is selectively deflected onto different image points of the projection surface via a micromirror unit, the deflection of the laser beam being increased via magnifying optics.

### FIELD OF THE INVENTION

The present invention is directed to a projection device, and a related method.

### BACKGROUND INFORMATION

Laser-based projection devices that include a micromirror unit for selectively deflecting the laser beam onto different image points of the projection surface play an increasingly important role in portable devices such as smart phones, cameras, PDAs, or tablet PCs. These types of image projectors are often based on raster scan methods in which the laser beam is imaged onto different image points of the projection surface, using adjustable micromirrors of the micromirror unit.

Such projection devices have proven suitable in applications in which image information is projected onto a projection surface, for example a wall, which is relatively far away from the mobile device. In such applications, typical projection distances are in the range of 1 m and greater.

In these types of portable devices there is a need for projecting image information at greatly reduced projection distances, for example to project a control panel or a keyboard in the immediate vicinity of the portable device. In this regard, the known projection devices have the disadvantage that due to the reduced projection distance, a projection surface results that is regarded as too small for many applications.

### SUMMARY OF THE INVENTION

An object of the present invention is to provide a projection device and a method for projecting image information which allow the projection of image information onto a projection surface at a smaller projection distance, without limiting the size of the projected image information.

The projection device according to the present invention and the method according to the present invention according to the other independent claim have the advantage over the related art that the maximum achievable deflection of the laser beam is increased by the magnifying optics. It is thus possible, even with a small projection distance, to obtain a sufficiently large projection surface.

The micromirror unit may include multiple micromechanical mirrors, which are also referred to below as micromirrors. One embodiment of the micromirror unit may be used in which the micromirror unit includes a first micromirror that is pivotable about a first axis, and a second micromirror that is pivotable about a second axis. The second axis may be situated at an angle, in particular orthogonally, with respect to the first axis.

Advantageous embodiments and refinements of the present invention are apparent from the subclaims, and from the description with reference to the drawings.

According to one advantageous embodiment, the projection device includes a collimating lens for collimating the laser beam. With the aid of the collimating lens, the laser beams emitted from the laser may be oriented essentially in parallel. The collimating lens in particular has a focal length that is in the range of less than 10 mm, which may be in the range of less than 5 mm, particularly which may be in the range of less than 3 mm. The collimating lens may be situated at what may be a small distance from the laser, so that a collimated laser beam having what may be a small diameter, in particular a diameter less than 1 mm, may be obtained. For example, the distance of the collimating lens from the laser may be in the range of less than 10 mm, which may be in the range of less than 5 mm, particularly in the range of less than 3 mm.

One embodiment may be used in which the projection device includes a focusing lens for focusing the laser beam that is collimated with the aid of the collimating lens. The focusing lens may focus the collimated laser beam in order to adapt the diameter of the laser beam to the aperture of the micromirror unit. In addition, it is possible to adapt to the magnifying optics and to the collimating lens by focusing the laser beam.

It is advantageous when a deflection element is situated in the beam path of the laser beam, between the micromirror unit and the magnifying optics. The direction of the laser beam may be changed via the deflection element, so that the projection onto a projection surface, which is inclined at an angle with respect to an exit plane of the micromirror unit, may take place. As a result of the deflection element, it is thus possible to provide the projection device in a mobile device which is situatable on a tabletop, so that image information may be projected onto the tabletop in the area in front of the mobile device. The deflection element may be configured as a mirror, in particular a flat mirror, or as a prism. Alternatively, the magnifying optics may include a deflection element, for example a convex mirror, that may deflect the laser beam and also increase the maximum deflection angle of the micromirror unit.

One embodiment has proven advantageous in which the projection device includes a correction lens having an adjustable focal length. Such an embodiment has the advantage that deformations of image information projected onto the projection surface, due to possible incorrect positioning of individual optical elements of the projection device with respect to one another, may be compensated for by changing the focal length of the correction lens. This embodiment allows greater tolerances in the positioning of the optical elements in the beam path of the laser beam. In conjunction with the use of a collimating lens, this results in the advantage that incorrect positioning of the collimating lens with respect to the laser may be compensated for by adjusting the focal length of the correction lens. The focal length of the correction lens may be electrically adjustable, so that the focal length may be adjusted by specifying an electrical signal.

The correction lens may be configured as a liquid lens, as a liquid crystal lens, or as a polymer lens. The correction lens may include a liquid, optically active core whose surface pattern is controllable via the effect of electrowetting. Alternatively, the correction lens may include a lens body made of a polymer that is deformable with the aid of an actuator, in particular a piezoelectric actuator.

One advantageous embodiment provides that the correction lens is situated in the beam path of the laser beam, in front of the micromirror unit. The course of the laser beam and its focusing may be corrected via the correction lens before the laser beam strikes the micromirror unit.

The correction lens may be situated in the beam path of the laser beam between a focusing lens and the micromirror unit, so that the already focused laser beam may be corrected via the correction lens.

One embodiment provides that the correction lens includes a signal input that is connected via a control line to a control unit for controlling the micromirror unit, or is connected to the micromirror unit. The control of the correction lens may be synchronized with the deflection of the micromirror unit via the control line in order to increase the resolution of the projected image. It is thus possible to make a dynamic correction of the projection as a function of the deflection position of the micromirror unit.

One embodiment of the method according to the present invention provides that the focal length of the correction lens is adjusted as a function of a deflection position of the micromirror unit. In a projection device that projects image information, whose image points have different projection distances, onto a projection surface, it is thus possible to adjust the focal length of the correction lens as a function of the projection distance in order to improve the image depiction.

Exemplary embodiments of the present invention are illustrated in the drawings and explained in greater detail in the following description.

### BRIEF DESCRIPTION OF THE DRAWINGS

FIG. 1 shows a portable device including a projection device according to one exemplary embodiment of the present invention, in a schematic side view.

FIG. 2 shows the portable device from FIG. 1 in a schematic top view.

FIG. 3 shows a first exemplary embodiment of a projection device according to the present invention in a schematic illustration.

FIG. 4 shows a schematic illustration of the beam path of a second exemplary embodiment of a projection device according to the present invention.

FIG. 5 shows a detailed illustration of the projection device according to FIG. 4.

FIG. 6 shows a schematic illustration of the beam path of a third exemplary embodiment of a projection device according to the present invention.

FIG. 7 shows a detailed illustration of the projection device according to FIG. 6.

FIG. 8 shows a flow chart of one exemplary embodiment of the method according to the present invention.

### DETAILED DESCRIPTION

FIG. 1 illustrates a portable device 1 that may be configured as a smart phone, a camera, a PDA, or a tablet PC, for example. Portable device 1 includes a housing and a projection device 2, situated inside the housing, which is configured as a picoprojector. A control panel and/or a keyboard may be projected in the immediate vicinity of portable device 1 with the aid of projection device 2. The projection may take place on a tabletop T, for example, on which portable device 1 rests. The portable device is set on tabletop T in such a way that projection device 2 is situated at a distance h from the tabletop that is typically less than 0.5 m. Distance h may, for example, be 0.1 m to 0.3 m, which may be 0.1 m to 0.15 m.

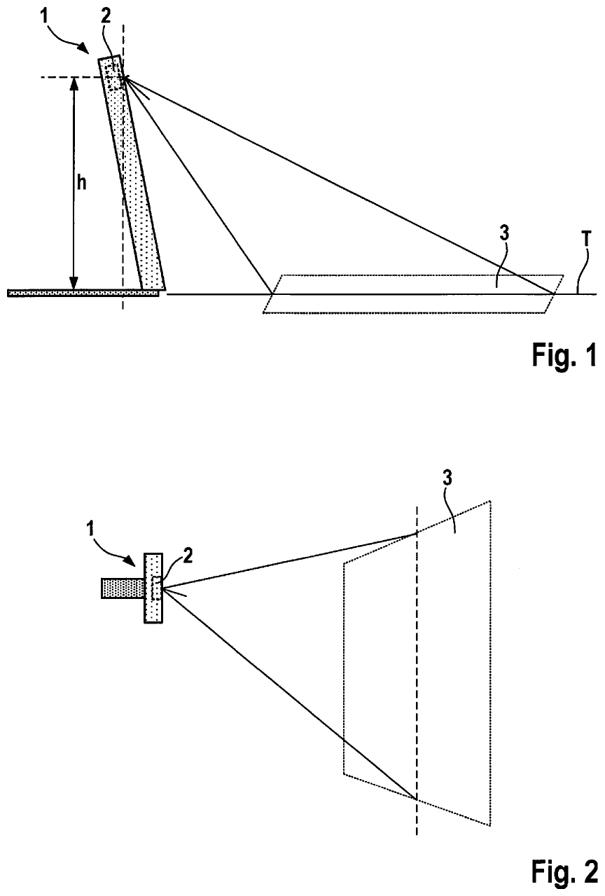

FIG. 2 shows a top view onto the portable device. It is apparent that trapezoidal distortion of the image information projected onto projection surface 3 occurs.

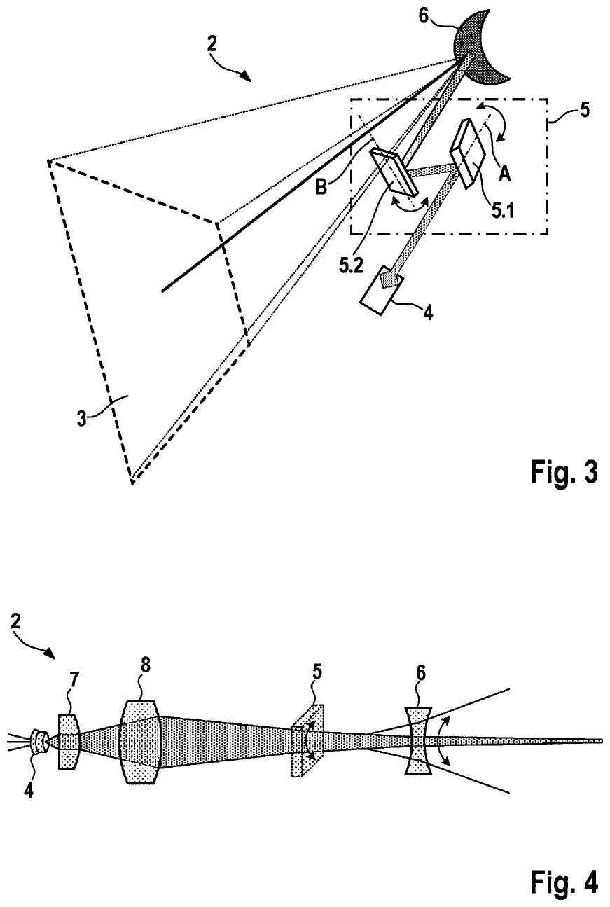

FIG. 3 illustrates a first exemplary embodiment of a projection device 2 according to the present invention for projecting image information onto a projection surface 3, which may be used in portable device 1. Projection device 2 includes a laser 4 that generates a laser beam. In addition, projection device 2 includes a micromirror unit 5 via which the laser beam may be selectively deflected onto individual image points of the projection surface. Micromirror unit 5 includes two micromechanical mirrors 5.1, 5.2. A first micromechanical mirror 5.1 of micromirror unit 5 is situated pivotably about a first axis A in order to deflect the laser beam in a first direction. A second micromechanical mirror 5.2 is pivotable about a second axis B positioned orthogonally to first axis A. The laser beam may be deflected in a direction orthogonal to the first direction via second micromechanical mirror 5.2. Via micromirror unit 5, the laser beam may be successively guided, in particular column by column and/or line by line, across individual image points of the projection surface.

To obtain what may be a large image on projection surface 3 despite the relatively small projection distance, projection device 2 includes magnifying optics 6, situated in the beam path of the laser beam, downstream from micromirror unit 5, for increasing the deflection of the laser beam that is achievable by micromirror unit 5. Magnifying optics 6 is configured as a convex mirror which on the one hand results in magnification of the image information projected onto the projection surface, and on the other hand deflects the laser beam, exiting from micromirror unit 5, in the direction of the projection surface.

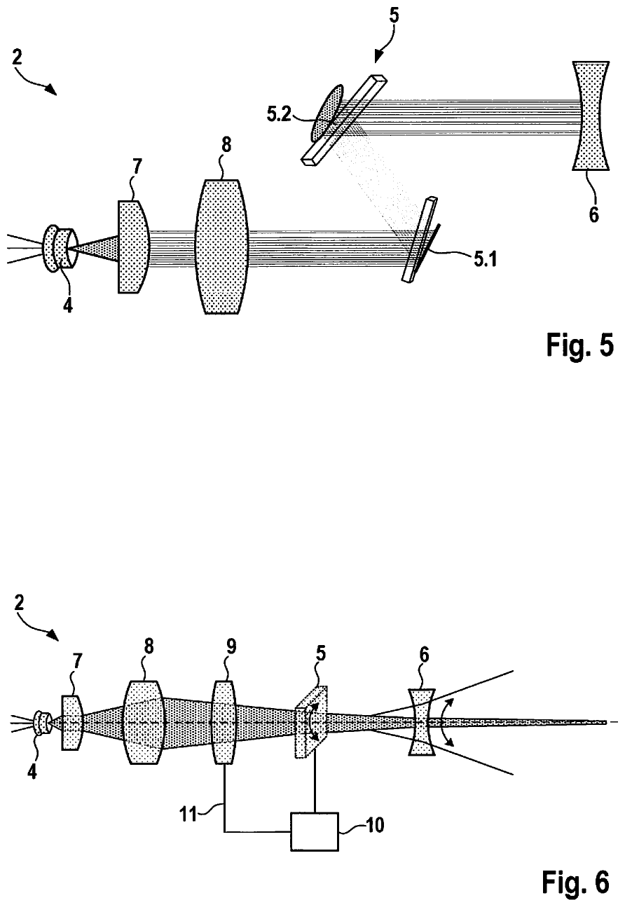

FIGS. 4 and 5 show a second exemplary embodiment of a projection device 2 according to the present invention. Projection device 2 includes a laser 4, and a collimating lens 7 for collimating the light generated by the laser. Situated in the beam path, downstream from collimating lens 7, is a focusing lens 8 that focuses the collimated laser beam and thus allows an adaptation of the laser beam to the aperture of micromirror unit 5. Projection device 2 includes magnifying optics 6 configured as a magnifying lens. A deflection element (not illustrated in FIGS. 4 and 5), for example a mirror or a prism, via which the laser beam may be deflected in the direction of projection surface 3 may optionally be provided in the beam path, between micromirror unit 5 and magnifying optics 6.

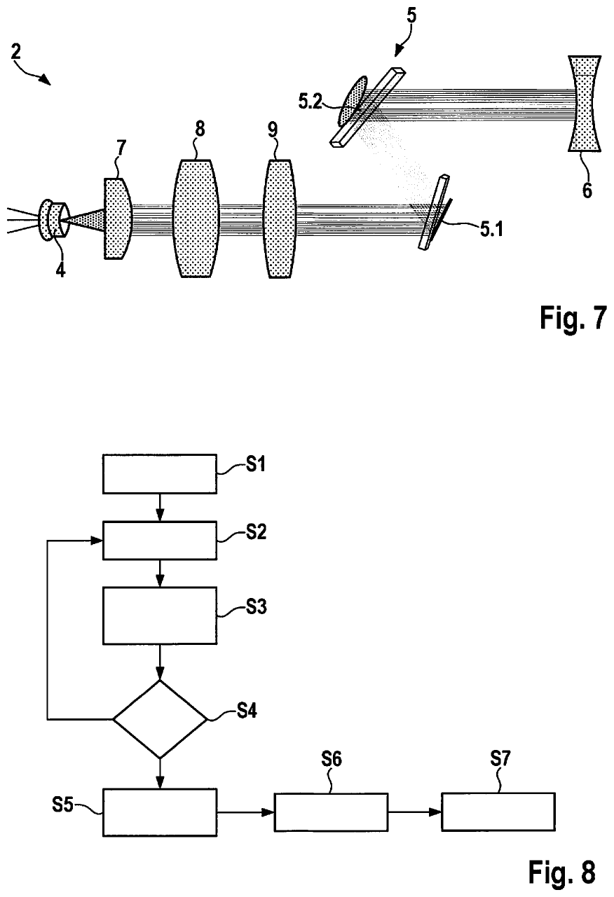

FIGS. 6 and 7 show a third exemplary embodiment of a projection device 2 according to the present invention. In addition to the elements described in conjunction with the projection device according to the second exemplary embodiment, projection device 2 according to the third exemplary embodiment includes a correction lens 9 having an electrically adjustable focal length. Correction lens 9 is configured as a liquid lens, as a liquid crystal lens, or as a polymer lens that is adjustable by applying an electrical control signal 11. Correction lens 9 is situated in the beam path between focusing lens 8 and micromirror unit 5. By adjusting the focal length of correction lens 9 it is possible to compensate for incorrect positioning of the collimating lens with respect to the laser.

The adjustment may take place automatically with the aid of a control unit 10, or manually by a user. For projection device 2 it is thus possible to adjust the sharpness of the image information imaged on projection surface 3.

Control unit 10 of projection device 2 is connected to correction lens 9 and to micromirror unit 5. Synchronized control of the focal length of correction lens 9 and of the deflection of micromirror unit 5 takes place via control unit 10, so that the focal point of the laser beam may be adjusted as a function of the deflection of the laser beam by micromirror unit 5. In this regard, the laser beam may be dynamically corrected during the projection. The control of correction lens 9 thus takes place at the same frequency at which micromirror unit 5 is operated for controlling the individual image points.

A deflection element, for example a mirror or a prism element (not illustrated in FIGS. 6 and 7), via which the laser beam may be deflected in the direction of projection surface 3 may optionally be provided in the beam path between micromirror unit 5 and magnifying optics 6.

A method for projecting image information onto a projection surface is described below with reference to the illustration in FIG. 8. A projection device 2 according to a third exemplary embodiment shown in FIGS. 6 and 7 may be used in this method.

In the method, a laser beam is generated with the aid of a laser 4 and is selectively deflected onto different image points of projection surface 3 by a micromirror unit 5. The deflection of the laser beam that is achievable by the micromirror unit is increased via magnifying optics 6 that is situated in the beam path, downstream from the micromirror unit.

In the method, the start of the projection takes place in a first method step S1; projection device 2 may run through an initialization sequence to initialize micromirror unit 5 and correction lens 9. Image information configured as test information is projected onto projection surface 3 in a second method step S2. The orientation of the image information on projection surface 3 as well as the adjustment of the image sharpness based on a change in the focal length of correction lens 9 take place in a third method step S3. A check is made in a fourth method step S4 as to whether the projection meets the requirements. If necessary, the second and third method steps may be repeated to improve the projection.

The area in which the focal length of correction lens 9 may be adjusted in order to obtain what may be a sharp image on projection surface 3 is computed in a fifth method step S5. The adjustment of the focal length of correction lens 9 is synchronized with the adjustment of the deflection of the laser beam by micromirrors 5.1, 5.2 of micromirror unit 5 in a sixth method step S6. The projection of the corrected image onto projection surface 3 takes place in a seventh method step S7.

In the projection devices 2 described above and the corresponding method for projecting image information onto a projection surface, the image of the image information may be magnified so that it is possible to project the image information onto a tabletop with a small projection distance, using a conventional micromirror unit 5. The described projection devices may be manufactured in a compact and cost-efficient manner. In projection device 2 according to the third exemplary embodiment, the positioning of the individual optical elements with respect to one another, in particular the positioning of collimating lens 7 with respect to laser 4, may be subject to greater tolerances, since a correction by correction lens 9 is possible. The user of projection device 2 according to the third exemplary embodiment may adjust the sharpness of the image on projection surface 3 by changing the focal length of correction lens 9.

1-12. (canceled)

13. A projection device for projecting image information onto a projection surface, comprising:
a laser for generating a laser beam; and
a micromirror unit to selectively deflect the laser beam onto different image points of the projection surface; and
a magnifying optic arrangement, situated in a beam path of the laser beam, downstream from the micromirror unit, for increasing a deflection of the laser beam that is achievable via the micromirror unit.

14. The projection device of claim 13, further comprising:
a collimating lens to collimate the laser beam.

15. The projection device of claim 13, further comprising:
a focusing lens to focus the laser beam that is collimated with the collimating lens.

16. The projection device of claim 13, wherein a deflection element is situated in the beam path of the laser beam, between the micromirror unit and the magnifying optic arrangement.

17. The projection device of claim 13, further comprising:
a correction lens having a focal length that is electrically adjustable.

18. The projection device of claim 13, wherein the correction lens includes a liquid lens, a liquid crystal lens, or a polymer lens.

19. The projection device of claim 13, wherein the correction lens is situated in the beam path of the laser beam, in front of the micromirror unit.

20. The projection device of claim 17, wherein the correction lens is situated in the beam path of the laser beam, between a focusing lens and the micromirror unit.

21. The projection device of claim 13, wherein the correction lens includes a signal input, which is connected one of: via a control line to a control unit for controlling the micromirror unit, or to the micromirror unit.

22. A method for projecting image information onto a projection surface, the method comprising:
generating a laser beam;
selectively deflecting the laser beam onto different image points of the projection surface with a micromirror unit; and
increasing a deflection of the laser beam via magnifying optics.

23. The method of claim 22, wherein a focal length of a correction lens is electrically adjustable.

24. The method of claim 23, wherein the focal length of the correction lens is adjusted as a function of a deflection position of the micromirror unit.

25. The projection device of claim 13, wherein a deflection element, which includes a mirror or a prism, is situated in the beam path of the laser beam, between the micromirror unit and the magnifying optic arrangement.
